(19) United States
(12) Patent Application Publication
(10) Pub. No.: US 2020/0347184 A1
(43) Pub. Date: Nov. 5, 2020

(54) POLYIMIDE PRECURSOR SOLUTION AND POLYIMIDE FILM USING SAME

(71) Applicant: LG CHEM, LTD., Seoul (KR)

(72) Inventors: Jinho LEE, Daejeon (KR); Jinyoung PARK, Daejeon (KR); Chae Won PARK, Daejeon (KR); Chan Hyo PARK, Daejeon (KR)

(73) Assignee: LG CHEM, LTD., Seoul (KR)

(21) Appl. No.: 16/961,177

(22) PCT Filed: Sep. 26, 2019
(86) PCT No.: PCT/KR2019/012490

§ 371 Date: Jul. 9, 2020

(30) Foreign Application Priority Data
Sep. 27, 2018 (KR) 10-2018-0114781
Aug. 20, 2019 (KR) 10-2019-0101527

(51) Int. Cl. C08G 73/10; C08J 5/18

(52) U.S. Cl. CPC C08G 73/1032; C08J 2379/08; C08J 5/18

(57) ABSTRACT

A polyimide precursor solution containing a reaction product of tetracarboxylic acid anhydride and diamine in a molar ratio of 1:0.93 to 1:0.99. The polyimide precursor solution contains a polyimide precursor having a number average molecular weight of at least 38,000 g/mol and can thus produce a polyimide film having high heat resistance. A polyimide precursor solution having improved storage stability can be provided by quantifying the defoaming properties of the solution and controlling the content of bubbles. Moreover, a polyimide film produced therefrom has a reduced amount of bubbles in the film, and can thus suppress the formation of cracks that can form in an inorganic layer when forming a device.

This application is a 35 U.S.C. 371 National Phase Entry Application from PCT/KR2019/12490 filed on Sep. 26, 2019, designating the United States, which claims the benefit of priorities to Korean Patent Application Nos. 10-2018-0114781, filed on Sep. 27, 2018, and 10-2019-0101527, filed on Aug. 20, 2019, the entire disclosures of which are incorporated herein by reference.

### BACKGROUND OF THE INVENTION

The present invention relates to a polyimide precursor solution and a polyimide film prepared therefrom, and more particularly, to a polyimide film prepared from a polyimide precursor solution having an improved defoaming rate.

In recent years, weight reduction and miniaturization of products have been emphasized in the field of display. However, a glass substrate is heavy and brittle and is difficult to apply to a continuous process. Accordingly, researches are actively carried out for applying a plastic substrate having advantages of lightness, flexibility, and applicability to continuous process and substitutable for a glass substrate, to a cell phone, a notebook and a PDA (Personal Digital Assistant).

In particular, a polyimide (PI) resin has an advantage that it is easy to be synthesized, can be formed into a thin film and does not require a crosslinking agent for curing. Recently, due to weight reduction and precision of electronic products, a polyimide is widely used as a material for integration in semiconductor such as LCD, PDP, etc. In particular, many studies have progressed for PI to use in a flexible plastic display board having light and flexible properties.

A polyimide (PI) film, which is produced by film-forming the polyimide resin, is generally prepared by solution polymerization of aromatic dianhydride and aromatic diamine or aromatic diisocyanate to prepare a solution of polyamic acid derivative, coating the solution on a silicon wafer or a glass, and curing by heat treatment.

### BRIEF DESCRIPTION OF THE INVENTION

The problem to be solved by the present invention is to provide a polyimide precursor solution with improved storage stability.

The present invention also provides a polyimide film prepared from the polyimide precursor solution.

Another problem to be solved by the present invention is to provide a flexible device using the polyimide film.

In order to solve the above problem, the present invention provides a polyimide precursor solution comprising a polyimide precursor prepared by reacting teteracarboxylic dianhydride and diamine in a molar ratio of 1:0.93 to 1:0.99 and having a number average molecular weight (Mn) of 38,000 g/mol or more, wherein the T value according to the following Equation 1 is 0.9 or more.

$$\frac{A}{B} = T \qquad [ Equation 1 ]$$

wherein,

A is a transmittance of the solution after leaving for 30 minutes after bubble generation, and

B is a transmittance of the solution before bubble generation.

According to one embodiment, the polyimide precursor may comprise a polymer prepared by reacting PDA (phenylenediamine) and BPDA (biphenyl dian hydride).

According to one embodiment, the polyimide precursor solution may have a transmittance before bubble generation of 75% or more, and the solution may have a transmittance after leaving for 30 minutes after bubble generation of 75% or more.

According to one embodiment, the transmittance of the polyimide precursor solution may be measured at a wavelength of 880 nm using Turbiscan (Formulaction, Turbisca LAB).

According to one embodiment, the polyimide precursor may have a number average molecular weight of less than 60,000 g/mol.

According to one embodiment, the solvent contained in the polyimide precursor solution may be a pyrrolidone-based solvent.

In order to solve the other problem of the present invention, the present invention provides a polyimide film prepared by curing the polyimide precursor solution.

According to one embodiment, the polyimide film may have a thermal decomposition temperature (Td_5%) of at least 600° C.

The present invention also provides a flexible device comprising the polyimide film.

The polyimide precursor solution according to the present invention comprises a polyimide precursor prepared by reacting tetracarboxylic dianhydride and diamine in a molar ratio of 1:0.93 to 1:0.99 and having a number average molecular weight of 38,000 g/mol or more, thereby producing a polyimide film having high heat resistance. In addition, it is possible to quantify defoaming properties of the polyimide precursor solution by transmittance to control the content of bubbles, thereby obtaining the polyimide precursor solution having the improved storage stability. In addition, the polyimide film prepared from the polyimide precursor solution according to the present invention can suppress crack formation in the inorganic film that may occur during device fabrication by reducing bubbles inside the film.

### DETAILED DESCRIPTION OF THE INVENTION

Since various modifications and variations can be made in the present invention, particular embodiments are illustrated in the drawings and will be described in detail in the detailed description. It should be understood, however, that the invention is not intended to be limited to the particular embodiments, but includes all modifications, equivalents, and alternatives falling within the spirit and scope of the invention. In the following description of the present invention, detailed description of known functions will be omitted if it is determined that it may obscure the gist of the present invention.

In the present disclosure, all compounds or organic groups may be substituted or unsubstituted, unless otherwise specified. Herein, the term “substituted” means that at least one hydrogen contained in the compound or the organic group is substituted with a substituent selected from the group consisting of a halogen atom, an alkyl group or a halogenated alkyl group having 1 to 10 carbon atoms, a cycloalkyl group having 3 to 30 carbon atoms, an aryl group having 6 to 30 carbon atoms, a hydroxyl group, an alkoxy group having 1 to 10 carbon atoms, a carboxylic group, an aldehyde group, an epoxy group, a cyano group, a nitro group, an amino group, a sulfonic group or a derivative thereof.

Currently, the display industries have manufactured display devices using plastic substrates instead of glass substrates to reduce weight and thickness of the substrate. In particular, a display device in which an OLED element is bonded to a plastic substrate has an advantage of being bent or folded.

In replacing a glass substrate with a plastic substrate, uniformity and process stability of the substrate are very important.

If foreign matters or bubbles exist inside and on the surface of the plastic substrate, cracking of the inorganic film may occur in the forming a thin film transistor (TFT) device. In particular, since the mobile charge caused by the micro bubbles in the film may affect the TFT driving, the defoaming process is performed for at least 8 hours before curing the polyimide precursor solution.

In order to solve such conventional problems, the present invention is intended to provide a polyimide precursor composition having a low bubble generation rate and a high defoaming rate and a film prepared therefrom.

The present invention provides a polyimide precursor solution comprising a polyimide precursor prepared by reacting teteracarboxylic dianhydride and diamine in a molar ratio of 1:0.93 to 1:0.99 and having a number average molecular weight (Mn) of 38,000 g/mol or more,

wherein the T value according to the following Equation 1 is 0.9 or more.

$$\frac{A}{B} = T \qquad [ Equation 1 ]$$

wherein,

A is a transmittance of the solution after leaving for 30 minutes after bubble generation, and

B is a transmittance of the solution before bubble generation.

Here, the transmittance may be measured by any method of measuring the transmittance of a solution containing particles, and is not particularly limited. For example, it may be measured at a wavelength of 880 nm using Turbiscan (Formulaction, Turbisca LAB).

The precursor solution of the present invention comprises a polyimide precursor having a high number average molecular weight of at least 38,000 g/mol or at least 40,000 g/mol. According to one embodiment, the number average molecular weight may be less than 60,000 g/mol or 55,000 g/mol or less or 50,000 g/mol or less. When the polyimide precursor satisfies the number average molecular weight in the above range, it has a solids content of the precursor solution of from 9% to 13% and a viscosity of from 1,000 to 5,000 cp, and it has a high degassing rate and improved heat resistance, compared to the precursor solution having a viscosity exceeding the above-mentioned range (for example, 7,000 to 20,000 cp). On the other hand, when the number average molecular weight of the polyimide precursor is lower than the above-mentioned range, the heat resistance and physical properties of the film may be poor, and thus a phenomenon such as film lifting during the process may occur.

The number average molecular weight of the polyimide precursor can be measured by various methods well known in the art, such as those described in the experimental examples described below.

In addition, in the present invention defoaming properties of the polyimide precursor solution can be quantified by the T value defined by Equation 1, and by using the T value, the content of bubbles present in the polyimide precursor solution can be more systematically controlled compared to controlling defoaming properties via visual observation. Accordingly, a polyimide precursor solution with the improved storage stability can be provided. That is, the polyimide film prepared from the polyimide precursor solution having a T value of 0.9 or more according to Equation 1 can not only maintain high heat resistance even in a high-temperature device process but also suppress crack formation generated due to bubbles remaining in the polyimide film effectively.

According to one embodiment, the polyimide precursor solution has a transmittance before bubble generation of 70% or more, preferably 75% or more, and the solution has a transmittance after leaving for 30 minutes after bubble generation of 70% or more, preferably 75% or more. That is, the difference in transmittance before bubble generation and after bubble generation is not large. In this case, bubble generation may be performed by rotating the precursor solution at 200 to 500 rpm for 20 to 60 seconds using a stirrer having the impeller connected.

The polyimide precursor is prepared by reacting tetracarboxylic dianhydride and diamine, and preferably is prepared by adding an excess of tetracarboxylic dianhydride relative to diamine, more preferably it may be prepared by reacting tetracarboxylic dianhydride and diamine in a molar ratio of 1:0.93 to 1:0.99, such as 1:0.93 to 1:0.98 or 1:0.94 to 1:0.98. If the molar ratio of the diamine to the tetracarboxylic dianhydride is less than 0.93, the heat resistance of the produced polyimide film may be lowered and if the molar ratio of the diamine to the tetracarboxylic dianhydride exceeds 0.99, for example if the tetracarboxylic dianhydride and the diamine are reacted in the same amount, defoaming characteristics may be lowered due to an increase in the viscosity of the solution, etc.

The polyimide precursor according to the invention can be obtained by polymerizing at least one tetracarboxylic dianhydride and at least one diamine.

According to one embodiment, the polyimide precursor may include a repeating structure formed by reacting BPDA (biphenyl dianhydride) as tetracarboxylic dianhydride and PDA (phenylenediamine) as diamine, for example include a repeating structure of the formula (1).

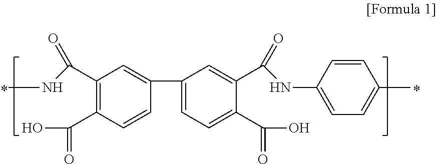

According to one embodiment, in the preparation of the polyimide precursor, it may further comprise at least one tetracarboxylic dianhydride together with BPDA.

For example, as the tetracarboxylic dianhydride, there is used a tetracarboxylic dianhydride containing an aromatic, alicyclic, or aliphatic tetravalent organic group, or a combination thereof in the molecule, wherein the aliphatic, alicyclic, or aromatic tetravalent organic group are cross-linked to each other. Preferably it may include an acid dianhydride having a structure in which monocyclic or polycyclic aromatics, monocyclic or polycyclic alicyclics, or two or more of these are connected by a single bond or a functional group. Alternatively, it may include tetracarboxylic dianhydrides comprising a tetravalent organic group having a rigid structure, wherein an aromatic ring or an aliphatic ring is a single ring structure, fused to each other to form a heterocyclic structure, or connected by a single bond.

For example, the tetracarboxylic dianhydride may comprise a tetravalent organic group selected from the structures of formulas 2a to 2e.

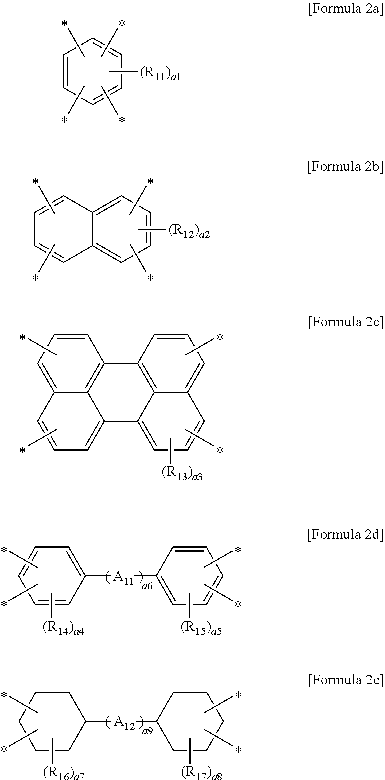

In the formulas 2a to 2e, R₁₁ to R₁₇ are each independently selected from a halogen atom selected from the group consisting of —F, —Cl, —Br and —I, a hydroxyl group (—OH), a thiol group (—SH), a nitro group (—NO₂), a cyano group, an alkyl group having 1 to 10 carbon atoms, a halogenoalkoxy group having 1 to 4 carbon atoms, a halogenoalkyl group having 1 to 10 carbon atoms and an aryl group having 6 to 20 carbon atoms,

a1 is an integer of 0 to 2, a2 is an integer of 0 to 4, a3 is an integer of 0 to 8, a4 and a5 are each independently an integer of 0 to 3, a6 and a9 are each independently an integer of 0 to 3, and a7 and a8 are each independently 0 to 7, and

A₁₁ and A₁₂ are each independently selected from the group consisting of a single bond, —O—, —CR₁₈R₁₉, —C(═O)—, —C(═O)NH—, —S—, —SO₂—, a phenylene group and a combination thereof, wherein R₁₈ and R₁₉ are each independently selected from the group consisting of a hydrogen atom, an alkyl group having 1 to 10 carbon atoms and a fluoroalkyl group having 1 to 10 carbon atoms.

Alternatively, the tetracarboxylic dianhydride may comprise a tetravalent organic group selected from the group consisting of the following formulas 3a to 3n.

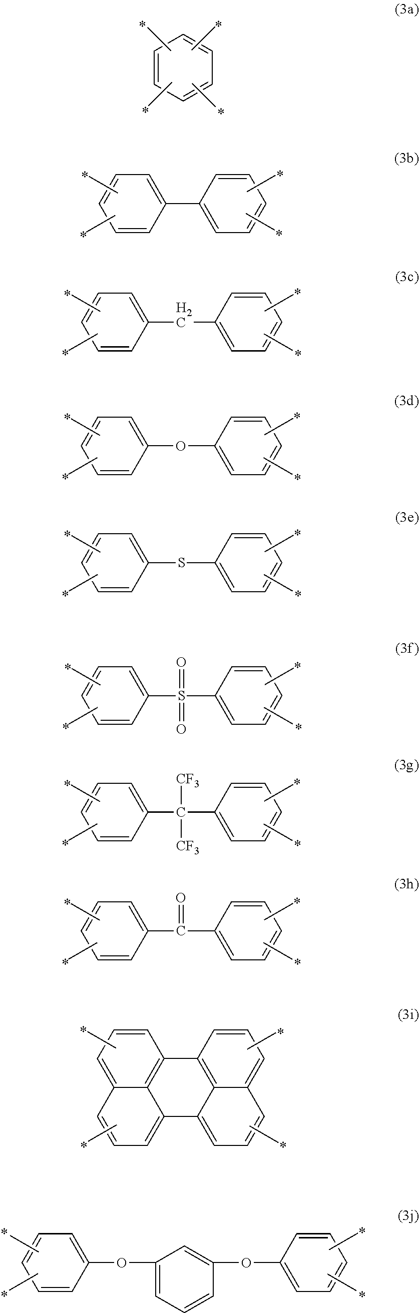

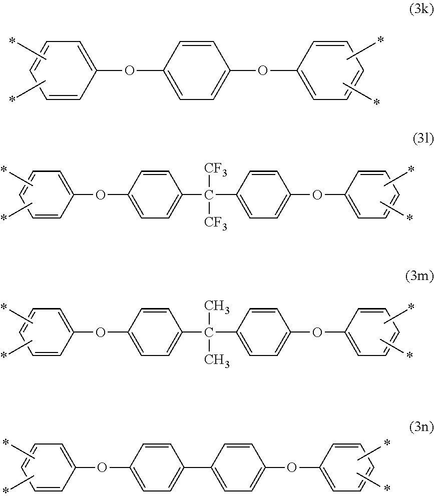

At least one hydrogen atom in the tetravalent organic group of formulas 3a to 3n may be substituted with a substituent selected from a halogen atom selected from the group consisting of —F, —Cl, —Br and —I, a hydroxyl group (—OH), a thiol group (—SH), a nitro group (—NO₂), a cyano group, an alkyl group having 1 to 10 carbon atoms, a halogenoalkoxy group having 1 to 4 carbon atoms, a halogenoalkyl group having 1 to 10 carbon atoms and an aryl group having 6 to 20 carbon atoms. For example, the halogen atom may be fluoro (—F), the halogenoalkyl group may be a fluoroalkyl group having 1 to 10 carbon atoms and comprising a fluoro atom, for example be selected from a fluoromethyl group, a perfluoroethyl group, a trifluoromethyl group, etc., the alkyl group may be selected from a methyl group, an ethyl group, a propyl group, an isopropyl group, a t-butyl group, a pentyl group, a hexyl group, etc., the aryl group may be selected from a phenyl group, a naphthalenyl group, more preferably a fluoro atom or a substituent containing a fluoro atom such as a fluoroalkyl group.

Alternatively, the tetracarboxylic dianhydrides may comprise a tetravalent organic group comprising an aromatic ring or an aliphatic ring in which each ring structure is a rigid structure, that is, a single ring structure, each ring is connected by a single bond, or each ring is directly connected to each other to form a heterocyclic structure, for example may comprise tetravalent organic group selected from the following formulas 4a to 4k.

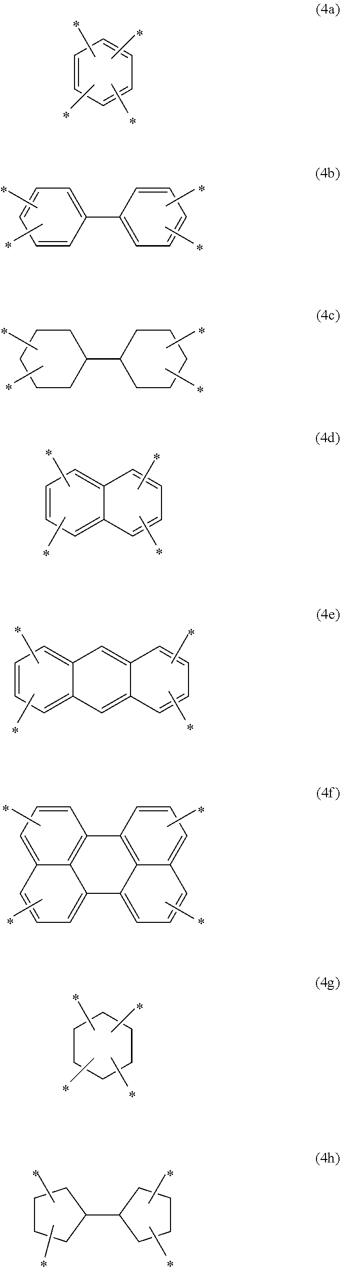

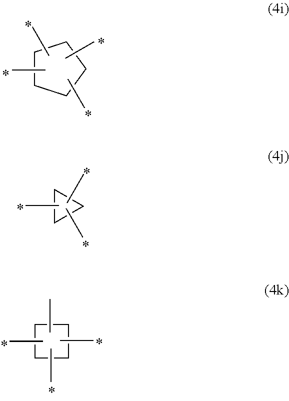

At least one hydrogen atom in the tetravalent functional group represented by formulas 4a to 4k may be substituted with a substituent selected from the group consisting of an alkyl group having 1 to 10 carbon atoms (e.g., methyl group, ethyl group, propyl group, isopropyl group, t-butyl group, pentyl group, hexyl group, etc.), a fluoroalkyl group having 1 to 10 carbon atoms (e.g., fluoromethyl group, perfluoroethyl group, trifluoromethyl group, etc.), an aryl group having 6 to 12 carbon atoms (e.g., phenyl group, naphthalenyl group, etc.), a sulfonic acid group and a carboxylic acid group, preferably substituted with a fluoroalkyl group having 1 to 10 carbon atoms.

According to one embodiment, in the preparation of the polyimide precursor, it may further comprise at least one diamine together with the PDA.

The diamine may include a diamine comprising a divalent organic group selected from a monocyclic or polycyclic aromatic divalent organic group having 6 to 24 carbon atoms, monocyclic or polycyclic alicyclic divalent organic group having 6 to 18 carbon atoms, or a divalent organic group including a structure in which two or more thereof are connected by a single bond or a functional group, alternatively, it may include a diamine comprising a divalent organic group having a rigid structure, wherein an aromatic ring or an aliphatic ring is a single ring structure, connected by a single bond, or fused to each other to form a heterocyclic structure.

For example, the diamine may comprise a divalent organic group selected from the formulas 5a to 5e.

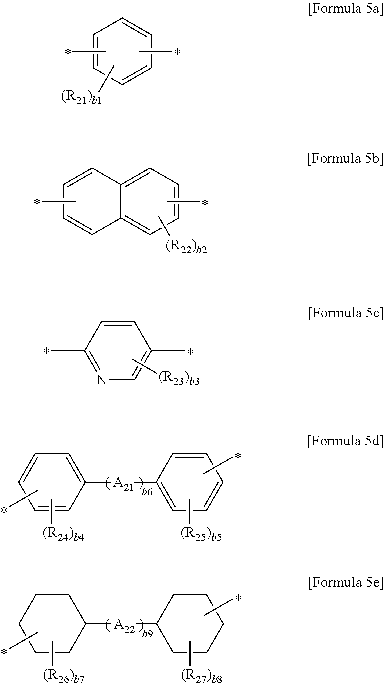

In the formulas 5a to 5e,

R₂₁ to R₂₇ are each independently selected from a halogen atom selected from the group consisting of —F, —Cl, —Br and —I, a hydroxyl group (—OH), a thiol group (—SH), a nitro group (—NO₂), a cyano group, an alkyl group having 1 to 10 carbon atoms, a halogenoalkoxy group having 1 to 4 carbon atoms, a halogenoalkyl group having 1 to 10 carbon atoms and an aryl group having 6 to 20 carbon atoms,

A₂₁ and A₂₂ are each independently selected from the group consisting of a single bond, —O—, —CR′R″— (wherein R′ and R″ are each independently a hydrogen atom, an alkyl group having 1 to 10 carbon atoms (e.g., methyl group, ethyl group, propyl group, isopropyl group, n-butyl group, tert-butyl group, pentyl group, etc.) and a haloalkyl group having 1 to 10 carbon atoms (e.g., trifluoromethyl group, etc.), —C(═O)—, —C(═O)O—, —C(═O)NH—, —S—, —SO—, —SO₂—, —O[CH2CH2O]y- (wherein y is an integer of 1 to 44), —NH(C═O)NH—, —NH(C═O)O—, a monocyclic or polycyclic cycloalkylene group having 6 to 18 carbon atoms (e.g., a cyclohexylene group), a monocyclic or polycyclic arylene group having 6 to 18 carbon atoms (e.g., a phenylene group, a naphthalene group, a fluorenylene group), and a combination thereof, and

b1 is an integer of 0 to 4, b2 is an integer of 0 to 6, b3 is an integer of 0 to 3, b4 and b5 are each independently an integer of 0 to 4, b7 and b8 are each independently an integer of 0 to 9, and b6 and b9 are each independently an integer of 0 to 3.

Alternatively, the diamine may comprise a divalent organic group selected from the group consisting of the formulas 6a to 6p.

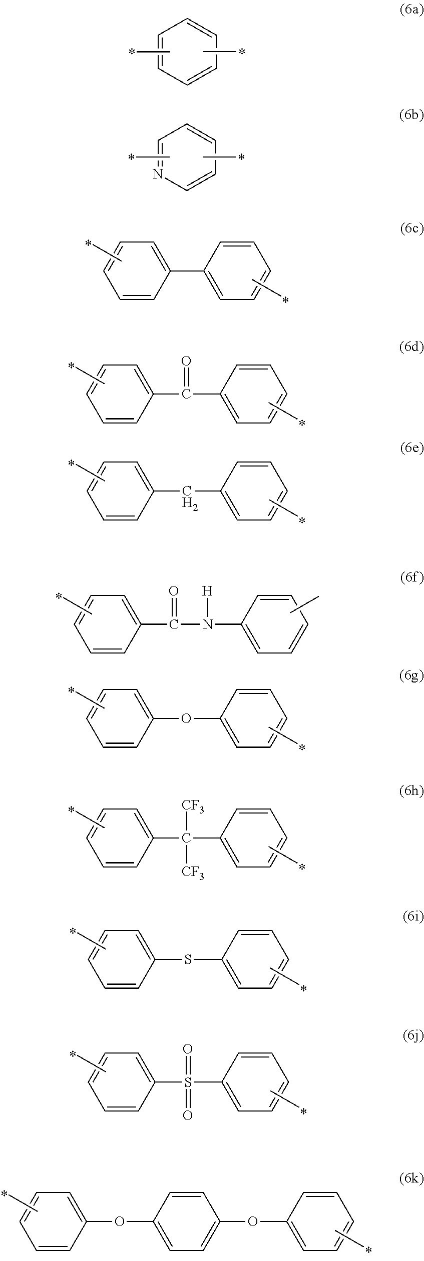

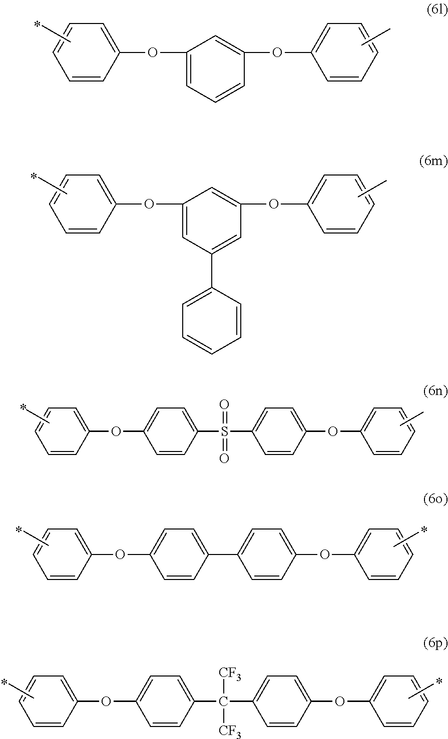

At least one hydrogen atom in the divalent organic group of formulas 6a to 6p may be substituted with a substituent selected from a halogen atom selected from the group consisting of —F, —Cl, —Br and —I, a hydroxyl group (—OH), a thiol group (—SH), a nitro group (—NO₂), a cyano group, an alkyl group having 1 to 10 carbon atoms, a halogenoalkoxy group having 1 to 4 carbon atoms, a halogenoalkyl group having 1 to 10 carbon atoms and an aryl group having 6 to 20 carbon atoms. For example, the halogen atom may be fluoro (—F), the halogenoalkyl group may be a fluoroalkyl group having 1 to 10 carbon atoms and comprising a fluoro atom, for example be selected from a fluoromethyl group, a perfluoroethyl group, a trifluoromethyl group, etc., the alkyl group may be selected from a methyl group, an ethyl group, a propyl group, an isopropyl group, a t-butyl group, a pentyl group, a hexyl group, etc., the aryl group may be selected from a phenyl group, a naphthalenyl group, more preferably a fluoro atom or a substituent containing a fluoro atom such as a fluoroalkyl group.

Alternatively, the diamine may comprise a divalent organic group having a rigid chain structure, wherein an aromatic ring or an aliphatic ring is a single ring structure, connected by a single bond, or fused to each other to form a heterocyclic structure. For example, it may comprise a divalent organic group selected from the formulas 7a to 7k, but is not limited thereto.

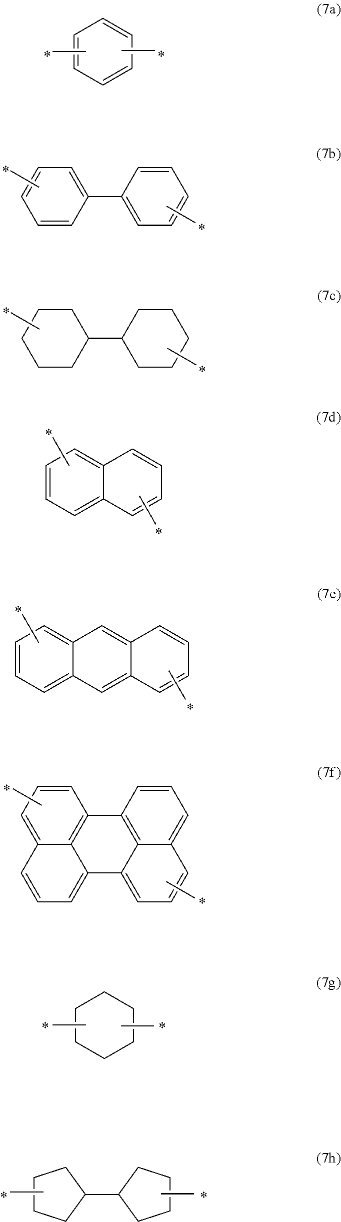

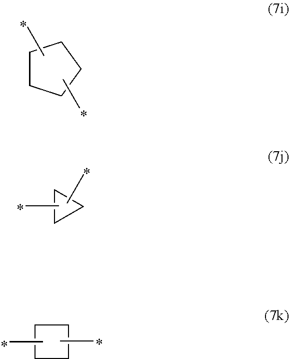

At least one hydrogen atom in the divalent functional group represented by formulas 7a to 7k may be substituted with a substituent selected from the group consisting of an alkyl group having 1 to 10 carbon atoms (e.g., methyl group, ethyl group, propyl group, isopropyl group, t-butyl group, pentyl group, hexyl group, etc.), a fluoroalkyl group having 1 to 10 carbon atoms (e.g., fluoromethyl group, perfluoroethyl group, trifluoromethyl group, etc.), an aryl group having 6 to 12 carbon atoms (e.g., phenyl group, naphthalenyl group, etc.), a sulfonic acid group and a carboxylic acid group, preferably substituted with a fluoroalkyl group having 1 to 10 carbon atoms.

As the content of the monomer having an organic group of a rigid structure, such as the formulas 4a to 4k or the formulas 7a to 7k increases, the heat resistance at a high temperature of the polyimide film may increase. It is possible to produce a polyimide film with improved transparency as well as heat resistance when used in combination with the organic group of a flexible structure.

The reaction of acid dianhydrides and diamines may be carried out by a conventional polymerization method of polyimide or its precursor, such as solution polymerization.

In addition, the organic solvent that can be used in the polymerization reaction of polyamic acid may be selected from the group consisting of ketones such as gamma-butyrolactone, 1,3-dimethyl-imidazolidinone, methyl ethyl ketone, cyclohexanone, cyclopentanone and 4-hydroxy-4-methyl-2-pentanone; aromatic hydrocarbons such as toluene, xylene and tetramethylbenzene; glycol ethers (Cellosolve) such as ethylene glycol monoethyl ether, ethylene glycol monomethyl ether, ethylene glycol monobutyl ether, diethylene glycol monoethyl ether, diethylene glycol monomethyl ether, diethylene glycol monobutyl ether, propylene glycol monomethyl ether, propylene glycol monoethyl ether, dipropylene glycol diethyl ether and triethylene glycol monoethyl ether; ethyl acetate, butyl acetate, ethylene glycol monoethyl ether acetate, ethylene glycol monobutyl ether acetate, diethylene glycol monoethyl ether acetate, dipropylene glycol monomethyl ether acetate, ethanol, propanol, ethylene glycol, propylene glycol, carbitol, dimethylpropionamide (DMPA), diethylpropionamide (DEPA), dimethylacetamide (DMAc), N,N-diethylacetamide, dimethylformamide (DMF), diethylformamide (DEF), N-methylpyrrolidone (NMP), N-ethylpyrrolidone (NEP), N,N-dimethylmethoxyacetamide, dimethylsulfoxide, pyridine, dimethylsulfone, hexamethylphosphoramide, tetramethylurea, N-methylcaprolactam, tetrahydrofuran, m-dioxane, p-dioxane, 1,2-dimethoxyethane, bis(2-methoxyethyl)ether, 1,2-bis(2-methoxyethoxy)ethane, bis[2-(2-methoxyethoxy)]ether, Equamide M100, Equamide B100 and the like, and these solvents may be used alone or as a mixture of two or more.

Preferably, sulfoxide-based solvents such as dimethyl sulfoxide and diethyl sulfoxide, formamide-based solvents such as N,N-dimethylformamide, N,N-diethylformamide, acetamide-based solvents such as N,N-dimethylacetamide, N,N-diethylacetamide, pyrrolidone-based solvents such as N-methyl-2-pyrrolidone, N-ethyl-2-pyrrolidone, and N-vinyl-2-pyrrolidone may be used alone or as a mixture, but the solvent is not limited thereto.

In addition, aromatic hydrocarbons such as xylene and toluene may be further used, and an alkali metal salt or alkaline earth metal salt of about 50% by weight or less based on the total amount of the solvent may be further added to the solvent to facilitate dissolution of the polymer.

In addition, in the case of synthesizing polyamic acid or polyimide, in order to inactivate excess polyamino group or acid anhydride group, an end-capping agent may be further added in which the terminal of the molecule reacts with dicarboxylic acid anhydride or monoamine to end-cap the terminal of the polyimide.

The reaction of tetracarboxylic dianhydride and diamine may be carried out by a conventional polymerization method of polyimide precursor, such as solution polymerization. Specifically, it can be prepared by dissolving diamine in an organic solvent, followed by polymerization by adding tetracarboxylic dianhydride to the resulting mixed solution.

The polymerization reaction may be carried out in an inert gas or a nitrogen stream, and may be carried out under anhydrous conditions.

The reaction temperature during the polymerization reaction may be −20 to 80° C., preferably 0 to 80° C. If the reaction temperature is too high, the reactivity may become high and the molecular weight may become large, and the viscosity of the precursor composition may increase, which may be unfavorable in the process.

It is preferable that the polyamic acid solution prepared according to the above-mentioned manufacturing method contains a solid content in an amount such that the composition has an appropriate viscosity in consideration of processibility such as coating property in the film forming process.

The polyimide precursor composition containing polyamic acid may be in the form of a solution dissolved in an organic solvent. For example, when the polyimide precursor is synthesized in an organic solvent, the solution may be the reaction solution as obtained, or may be obtained by diluting this reaction solution with another solvent. When the polyimide precursor is obtained as a solid powder, it may be dissolved in an organic solvent to prepare a solution.

According to one embodiment, the solid content of the composition may be adjusted by adding an organic solvent in an amount such that the content of total polyimide precursor is 8 to 25% by weight, preferably 10 to 25% by weight, more preferably 10 to 20% by weight or less.

Alternatively, the polyimide precursor composition may be adjusted to have a viscosity of 3,000 cP or more, or 4,000 cP or more. The viscosity of the polyimide precursor composition is 10,000 cP or less, preferably 9,000 cP or less, more preferably 8,000 cP or less. When the viscosity of the polyimide precursor composition exceeds 10,000 cP, the efficiency of defoaming during processing of the polyimide film is lowered. It results in not only the lowered efficiency of process but also the deteriorated surface roughness of the produced film due to bubble generation. It may lead to the deteriorated electrical, optical and mechanical properties. The viscosity of the polyimide precursor composition can be measured by methods well known in the art, for example, Viscotek TDA302 can be used for measurement of viscosity.

Then, the polyimide precursor resulted from the polymerization reaction may be imidized to prepare a transparent polyimide film.

According to one embodiment, the polyimide film may be manufactured by a method comprising the steps of:

applying the polyimide precursor solution onto a substrate; and

thermal treating the applied polyimide precursor solution.

As the substrate, a glass substrate, a metal substrate, a plastic substrate, or the like can be used without any particular limitation. Among them, a glass substrate may be preferable which is excellent in thermal and chemical stabilities during imidization and curing processes for the polyimide precursor and can be easily separated even without any treatment with additional release agent while not damaging the polyimide film formed after curing.

The application process may be carried out according to a conventional application method. Specifically, a spin coating method, a bar coating method, a roll coating method, an air knife method, a gravure method, a reverse roll method, a kiss roll method, a doctor blade method, a spray method, a dipping method, a brushing method, or the like may be used. Of these, it is more preferable to carry out by a casting method which allows a continuous process and enables to increase an imidization rate of polyimide.

In addition, the polyimide precursor composition may be applied on the substrate in a thickness range such that the polyimide film to be finally produced has a thickness suitable for a display substrate.

Specifically, it may be applied in an amount such that the thickness is 10 to 30 μm. After the application of the polyimide precursor composition, a drying process for removing the solvent remained in the polyimide precursor composition may be further optionally performed prior to the curing process.

The drying process may be carried out according to a conventional method. Specifically, the drying process may be carried out at a temperature of 140° C. or lower, or from 80° C. to 140° C. If the drying temperature is lower than 80° C., the drying process becomes longer. If the drying temperature exceeds 140° C., the imidization proceeds rapidly, making it difficult to form a polyimide film having a uniform thickness.

Then, the polyimide precursor composition applied on a substrate is heat-treated in an IR oven, in a hot air oven, or on a hot plate. The heat treatment temperature may range from 300 to 500° C., preferably from 320 to 480° C. The heat treatment may be performed in a multi-step heating process within the above temperature range. The heat treatment process may be performed for 20 to 70 minutes, and preferably for 20 to 60 minutes.

Thereafter, the polyimide film can be produced by peeling the polyimide film from the substrate according to a conventional method.

In addition, the polyimide film prepared from the polyimide precursor solution according to the present invention may have excellent thermal stability with respect to a temperature change, for example, the polyimide film may have a thermal decomposition temperature (Td 5%) of at least 600° C.

In addition, the polyimide may have a glass transition temperature of about 360° C. or more. Since it has such excellent heat resistance, the film containing the polyimide can maintain the excellent heat resistance and mechanical property with respect to the high temperature heat added during the manufacturing process of the device.

Pores in the polyimide film may cause cracks on the inorganic film (polysilicon thin film) by a high temperature heat treatment process in a low temperature polysilicon (LTPS) TFT process. Therefore, in the present invention, the content of bubbles remaining in the polyimide precursor solution can be controlled by quantifying the defoaming properties in the polyimide precursor and adjusting it below a specific value. Therefore, it is possible to suppress or significantly reduce the occurrence of cracks on the inorganic film layer which may be caused by residual bubbles in the polyimide film produced therefrom.

The polyimide film according to the present invention can be useful for the production of flexible devices in electronic devices such as OLEDs or LCDs, electronic papers, solar cells, particularly, as substrates of flexible devices.

Hereinafter, embodiments of the present invention will be described in detail so that those skilled in the art can easily carry out the present invention. The present invention may, however, be embodied in many different forms and should not be construed as limited to the embodiments set forth herein.

### <Example 1> BPDA:PDA=1:0.967

0.059 mol of PDA (phenylendiamine) was dissolved in 100 g of N-methylpyrrolidone (NMP) with stirring for 20 minutes in a nitrogen atmosphere. 0.061 mol of BPDA (biphenyl dianhydride) was added to the PDA solution together with 80 g of NMP, and then reacted at 30° C. for 12 hours to prepare a polyimide precursor solution.

### <Example 2> BPDA:PDA=1:0.98

A polyimide precursor solution was prepared in the same manner as in Example 1 except that 0.060 mol of PDA was used.

### <Example 3> BPDA:PDA=1:0.936

A polyimide precursor solution was prepared in the same manner as in Example 1 except that 0.063 mol of BPDA was used.

### <Comparative Example 1> BPDA:PDA=1:1

A polyimide precursor solution was prepared in the same manner as in Example 1 except that 0.061 mol of PDA was used.

### <Comparative Example 2> BPDA:PDA=1:0.922

A polyimide precursor solution was prepared in the same manner as in Example 1 except that 0.064 mol of BPDA was used.

### <Experimental Example 1> Measurement of Number Average Molecular Weight

The number average molecular weight of the polyimide precursors prepared in Examples 1 to 3 and Comparative Examples 1 and 2 was measured under the following conditions.

GPC (Gel permeation chromatography): Viscotek TDA302, Malvern

Detector: RI (Refractive Index), Laser detector

Column temperature: 40° C.

Standard: PS (polystyrene, MW:105,000)

Eluting solvent: DMF (dimethylformamide)+THF (tetrahydrofuran) (LiBr, H₃PO₄)

### <Experimental Example 2> Measurement of Transmittance of Polyimide Precursor Solution

The polyimide precursor solutions prepared in Examples 1 to 3 and Comparative Examples 1 and 2 were prepared to measure the transmittance before bubble generation at room temperature, immediately after bubble generation, and after leaving for 30 minutes after bubble generation, receptively. In this case, bubble generation was performed by rotating the precursor solution at 300 rpm for 30 seconds using a stirrer having the impeller connected. The transmittance of the solution was measured at a wavelength of 880 nm using Turbiscan (Formulaction, Turbisca LAB), and the measured value was substituted into Equation 1 below to calculate a “T” value.

$$\frac{A}{B} = T \qquad [ Equation 1 ]$$

wherein,

A is a transmittance of the solution after leaving for 30 minutes after bubble generation, and

B is a transmittance of the solution before bubble generation.

### <Experimental Example 3> Measurement of Heat Resistance of Polyimide Film

Each of the polyimide precursor solutions of Examples 1 to 3 and Comparative Example 1 and 2 was spin coated on a glass substrate. The glass substrate coated with the polyimide precursor solution was placed in an oven and heated at a rate of 5° C./min, and maintained for 30 minutes at 80° C. and for 30 minutes at 400° C. to form a polyimide film having a thickness of 10 μm.

For each polyimide film prepared, the thermal decomposition temperature (Td_5%) is defined as a temperature at which the weight loss of the polymer was 5% as measured in a nitrogen atmosphere using TGA.

The measurement results are shown in Table 1 below.

TABLE 1

| | | | | Comparative | Comparative |
|---|---|---|---|---|---|
| | Example 1 | Example 2 | Example 3 | Example 1 | Example 2 |
| BPDA:PDA | 1:0.0967 | 1:0.98 | 1:0.936 | 1:1 | 1:0.922 |
| (molar ratio) | | | | | |
| Transmittance before | 78 | 78 | 79 | 76 | 80 |
| bubble generation (%) | | | | | |
| Transmittance | 33 | 28 | 33 | 28 | 38 |
| immediately after bubble | | | | | |
| generation (%) | | | | | |
| Transmittance after | 78 | 72 | 79 | 64 | 80 |
| leaving for 30 minutes | | | | | |
| (%) | | | | | |
| T | 1 | 0.92 | 1 | 0.84 | 1 |
| Number average | 45,000 | 53,000 | 38,000 | 60,000 | 35,000 |
| molecular weight | | | | | |
| Thermal decomposition | >600 | >600 | 600 | >600 | 585 |
| temperature (Td_5%), | | | | | |
| ° C. | | | | | |

As can be seen from Table 1, it can be seen that the transmittance of the polyimide precursor solutions according to Example 1 to 3 which comprise a polyimide precursor prepared by reacting tetracarboxylic dianhydride and diamine in a molar ratio of 1:0.93 to 1:0.99 and having a number average molecular weight (Mn) of 38,000 g/mol or more, is almost restored to the state before bubble generation, after about 30 minutes of bubble generation. This is because defoaming rapidly occurs after bubble generation, and thus the storage stability of the polyimide precursor solution can be improved.

In the case of Comparative Example 1 in which BPDA and PDA were polymerized in the same molar ratio, the polymerized polyimide precursor has a high number average molecular weight, but the solution has a high viscosity, indicating that the defoaming property was lowered. This can be proved by the T value of Equation 1 representing 0.9 or less.

In the case of Comparative Example 2 in which BPDA is excessively reacted relative to PDA, it can be seen that the molecular weight is low, resulting in deterioration of the thermal decomposition characteristics.

As such, the present invention provides a polyimide precursor solution having improved defoaming properties by using a polyimide precursor having high number average molecular weight, thereby improving heat resistance of the polyimide film and suppressing crack formation due to bubbles remaining inside the polyimide film during a high temperature process.

While the present invention has been particularly shown and described with reference to specific embodiments thereof, it will be apparent to those skilled in the art that this specific description is merely a preferred embodiment and that the scope of the invention is not limited thereby. It is therefore intended that the scope of the invention be defined by the claims appended hereto and their equivalents.

1. A polyimide precursor solution comprising a polyimide precursor wherein the polyimide precursor is a reaction product of teteracarboxylic dianhydride and diamine in a molar ratio of 1:0.93 to 1:0.99 and has a number average molecular weight (Mn) of at least 38,000 g/mol,
wherein a T value according to Equation 1 is at least 0.9.
$$\frac{A}{B} = T \qquad [ Equation 1 ]$$
wherein,
A is a transmittance of the solution measured at a wavelength of 880 nm after leaving for 30 minutes after bubble generation in the solution at a room temperature, and
B is a transmittance of the solution measured at a wavelength of 880 nm before bubble generation.

2. The polyimide precursor solution according to claim 1, wherein the polyimide precursor comprises a repeating unit produced from a reaction of PDA (phenylenediamine) and BPDA (biphenyl dianhydride).

3. The polyimide precursor solution according to claim 1, wherein the transmittance A and transmittance B of the solution are at least 75%, respectively.

4. The polyimide precursor solution according to claim 1, wherein the transmittance is measured using Turbiscan.

5. The polyimide precursor solution according to claim 1, wherein the polyimide precursor has a number average molecular weight of less than 60,000 g/mol.

6. The polyimide precursor solution according to claim 1, wherein the polyimide precursor solution comprises the polyimide precursor and a pyrrolidone-based solvent.

7. A polyimide film comprising a cured product of the polyimide precursor solution according to claim 1.

8. The polyimide film according to claim 7, wherein the polyimide film has a thermal decomposition temperature, Td_5% of at least 600° C.

9. A flexible device comprising the polyimide film according to claim 7 as a substrate.

10. The polyimide precursor solution according to claim 2, further comprising at least one tetracarboxylic dianhydride together with the BPDA.

11. The polyimide precursor solution according to claim 1, wherein the bubble generation is performed by rotating the precursor solution at 200 to 500 rpm for 20 to 60 seconds.

12. The polyimide precursor solution according to claim 6, wherein the pyrrolidone-based solvent is at least one solvent selected from N-methyl-2-pyrrolidone, N-ethyl-2-pyrrolidone and N-vinyl-2-pyrrolidone.

13. A method for preparing a polyimide film comprising the steps of:
applying the polyimide precursor solution of claim 1 onto a substrate; and
thermal treating the applied polyimide precursor solution at 300 to 500° C. to produce the polyimide film.

14. The method of according to 13, further comprising drying the polyimide film at a temperature of 140° C. or lower.
